(19) United States
(12) Patent Application Publication
(10) Pub. No.: US 2004/0188574 A1
(43) Pub. Date: Sep. 30, 2004

(54) Adjustable television stand

(75) Inventors: Matthew Weatherly, Belton, MO (US); Daniel Whyman, Lamar, MO (US)

Correspondence Address: HAYNES AND BOONE, LLP, 901 MAIN STREET, SUITE 3100, DALLAS, TX, 75202, US

(73) Assignee: O'Sullivan Industries, Inc., Lamar, MO (US)

(21) Appl. No.: 10/805,751

(22) Filed: Mar. 22, 2004

Related U.S. Application Data
(63) Continuation-in-part of application No. 10/752,908, filed on Jan. 7, 2004.
(60) Provisional application No. 60/458,985, filed on Mar. 31, 2003.

(51) Int. Cl. F16M 11/00

(52) U.S. Cl. 248/161

(57) ABSTRACT

An adjustable stand including at least one support and at least one adjustable bracket engaged with and adjustable along the support. The adjustable bracket includes a recess in a surface adjacent the support and at least one protrusion extending from a surface of the recess. The adjustable stand also includes at least one mounting bracket including: (1) at least one retaining portion configured to interface with a device to be supported by the adjustable stand; and (2) at least one flange portion configured to engage with the recess and the protrusion.

### CROSS-REFERENCE TO RELATED APPLICATIONS z

This application is a continuation-in-part of the common-assigned, pending U.S. patent application Ser. No. 10/752,908 entitled “ADJUSTABLE TELEVISION STAND,” filed on Jan. 7, 2004, which claims the benefit of U.S. Provisional Application No. 60/458,985, filed on Mar. 31, 2003.

### BACKGROUND

The present disclosure relates generally to adjustable furniture and, more particularly, to a television stand that is adjustable to support televisions of different sizes.

Appliances, such as televisions, are often housed on or within stands or similar furniture assemblies (e.g., entertainment centers). Such assemblies may present a surface on which a television may be placed, or may provide an attachment mechanism that holds the television. As televisions come in a variety of different sizes and shapes, it may be difficult to find a stand or other assembly that will fit a particular television.

Therefore, what is needed is an adjustable television stand that can support televisions of different sizes and shapes.

### BRIEF DESCRIPTION OF THE DRAWINGS

FIG. 1 is a front perspective view of an adjustable television stand according to one embodiment of the present disclosure.

FIG. 2 is a side view of the adjustable television stand of FIG. 1.

FIG. 3 is a front view of the adjustable television stand of FIG. 1.

FIG. 4 is a back view of the adjustable television stand of FIG. 1.

FIG. 5a is a detailed perspective view depicting a clamp member and an adjustable bracket associated with the adjustable television stand of FIG. 1.

FIG. 5b is a partial exploded view of the detailed portion of the adjustable television stand depicted in FIG. 5a.

FIG. 6 is a front perspective view of an alternative adjustable television stand according to another embodiment of the present disclosure.

FIG. 7 is a back perspective view of the adjustable television stand of FIG. 6.

FIG. 8 is an exploded view of a portion of the adjustable television stand of FIG. 6.

FIG. 9 is a perspective view of another embodiment of an adjustable stand according to aspects of the present disclosure.

FIG. 10 is an exploded view of a portion of the adjustable stand of FIG. 9.

### Description

The present disclosure relates to adjustable furniture and, more particularly, to a television stand that is adjustable to support televisions of different sizes and shapes. It is understood, however, that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

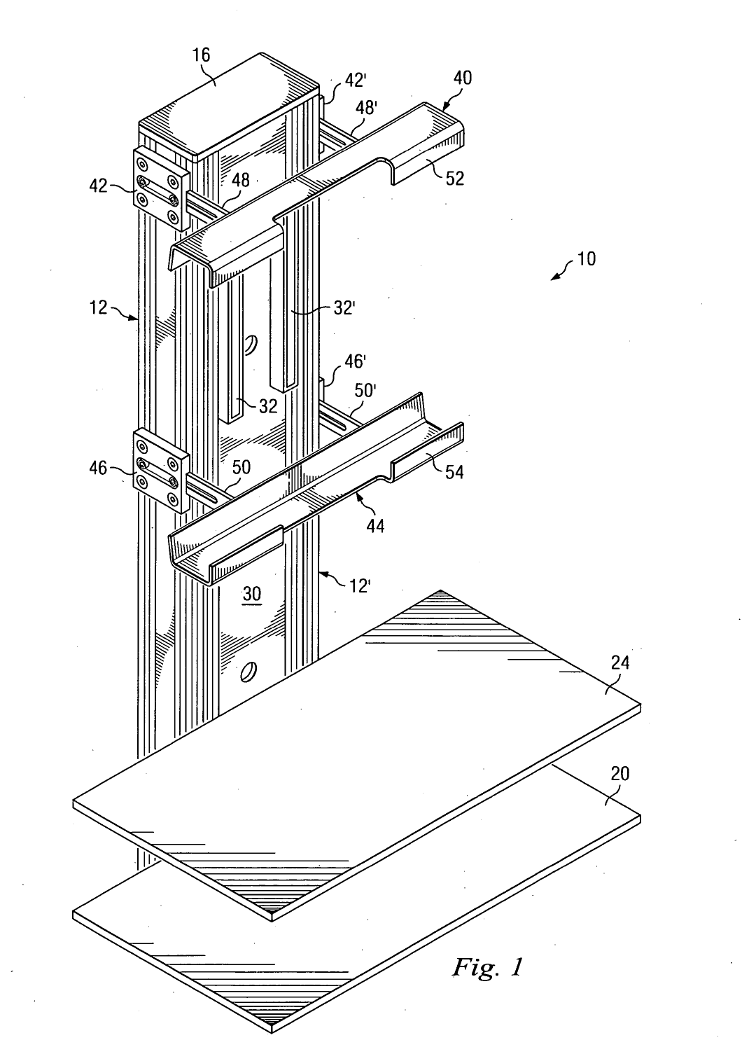

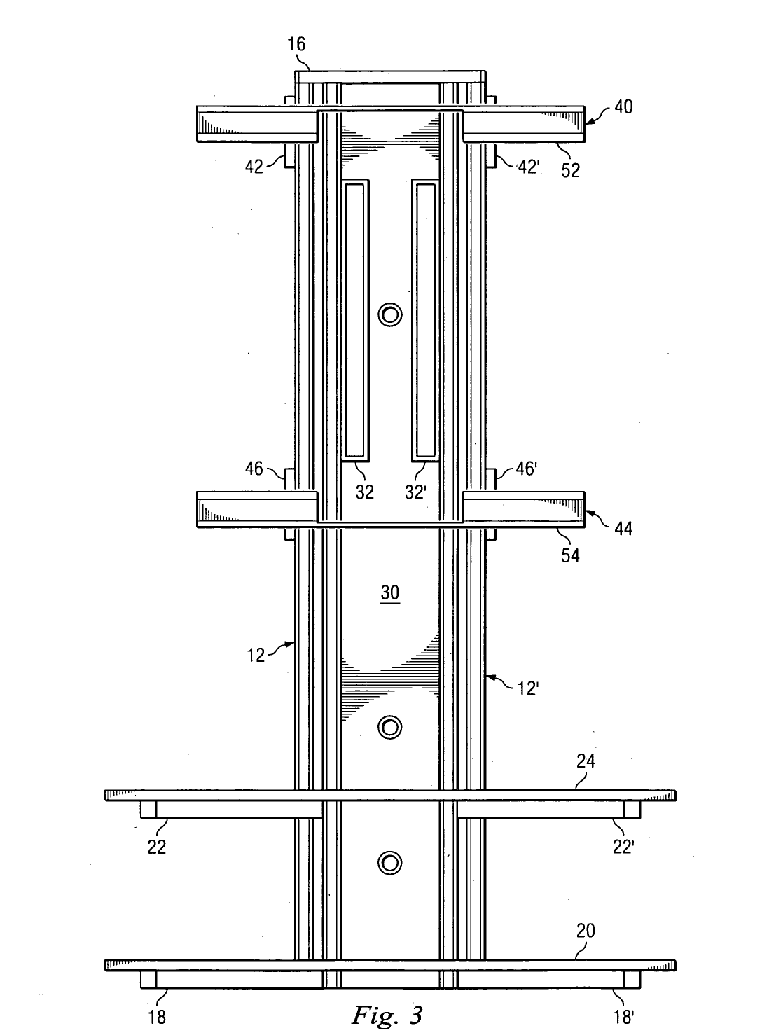

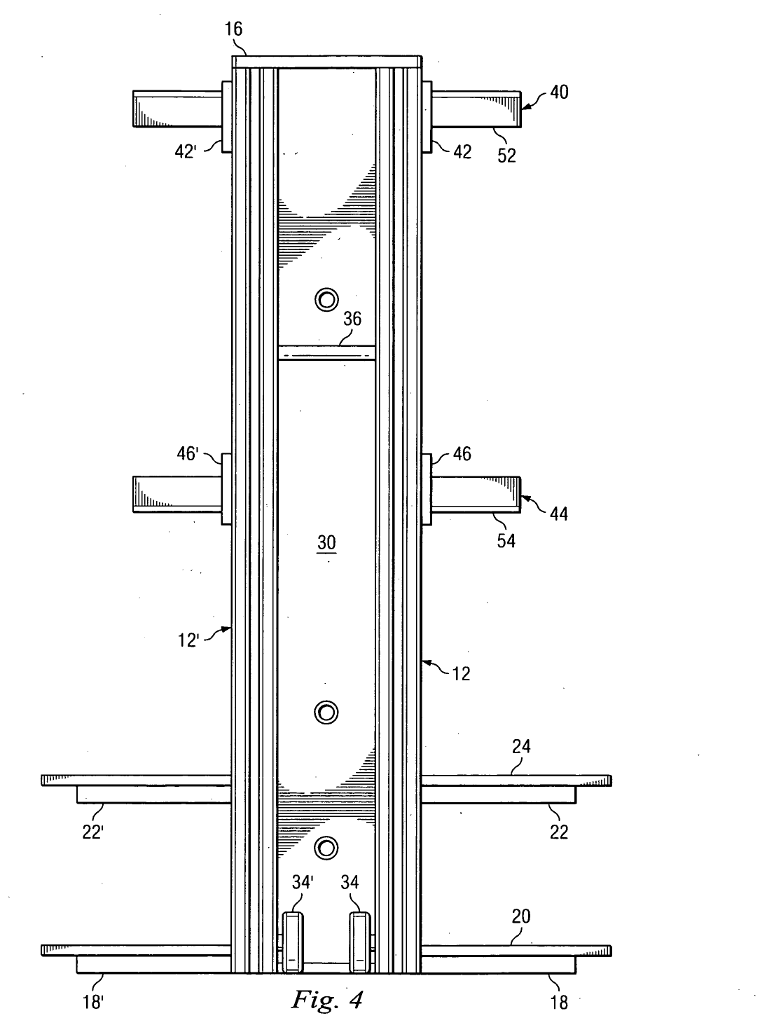

Referring to FIGS. 1-4, an adjustable television stand is generally referred to by reference numeral 10. The stand 10 includes a pair of parallel, horizontally spaced, vertical supports 12, 12′. It is understood that substantially identical components are given the same reference numerals in this specification. Although substantially identical components are given the same reference numerals, the components on the right side of the stand 10 in FIGS. 1-3 (on the left side of the stand 10 in FIG. 4) are given an apostrophe (“′”) to simplify the following explanation of the stand 10. The upper ends of the vertical supports 12, 12′ (as viewed in FIG. 1) are connected via a plate 16, which is secured to the vertical supports in any conventional manner. A pair of horizontally-extending supports 18, 18′ (FIG. 3) are connected in any conventional manner to the vertical supports 12, 12′, respectively, and extend therefrom to provide the stand 10 with an appreciable degree of stability when resting on a surface. As such, the horizontally-extending supports 18, 18′ extend such that they are angled away from each other to provide support for the stand 10. A shelf 20 is disposed transversely across the upper surfaces of the horizontally-extending supports 18, 18′ (as viewed in FIG. 1) to provide the stand 10 with a storage area.

A pair of horizontally-extending shelving supports 22, 22′ (FIG. 3), vertically-spaced from the supports 18, 18′, are connected in any conventional manner to the vertical supports 12, 12′, respectively, and extend therefrom to support an additional shelf 24 associated with the stand 10. A panel 30 is connected between the vertical supports 12, 12′ in any conventional manner, and includes a pair of stop members 32, 32′ disposed thereon for reasons to be described. Referring to FIG. 4, a pair of wheels 34, 34′ are operatively connected to the vertical supports 12, 12′ proximate to a lower end of the stand 10 (as viewed in FIG. 4), thereby facilitating movement of the stand. A handle 36 (FIG. 4) is further connected between the vertical supports 12, 12′ in any conventional manner to further facilitate movement of the stand.

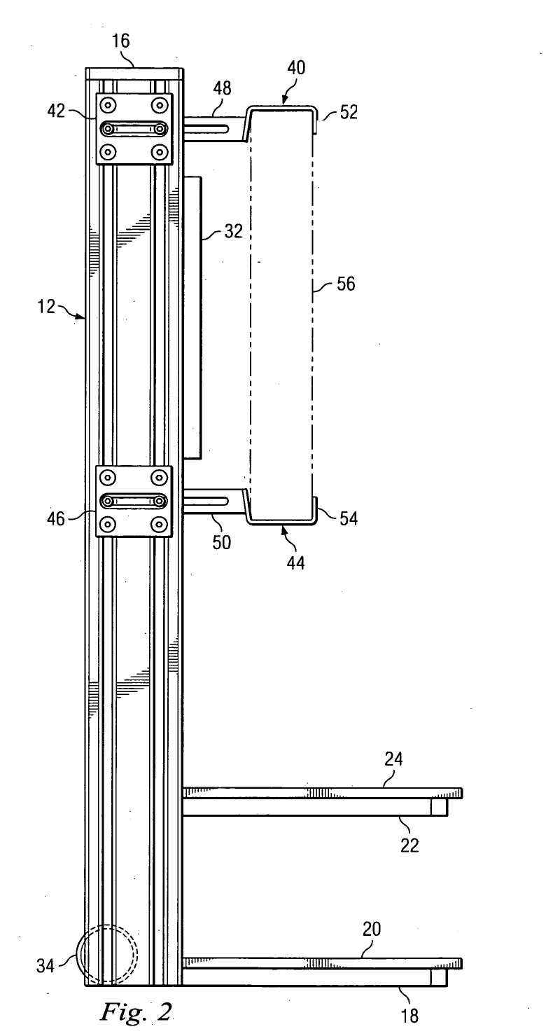

Referring again to FIGS. 1-4, an upper clamp member 40 is adjustably secured to the vertical supports 12, 12′ by adjustable brackets 42, 42′, respectively, as will be further described. Similarly, a lower clamp member 44 is adjustably secured to the vertical supports 12, 12′ by adjustable brackets 46, 46′, respectively. The clamp member 40 includes a pair of flange portions 48, 48′ (FIGS. 1 and 2) for connecting the clamp member 40 to the adjustable brackets 42, 42′, respectively. Similarly, the clamp member 44 includes a pair of flange portions 50, 50′ (FIGS. 1 and 2) for connecting the clamp member 44 to the adjustable brackets 46, 46′, respectively.

The clamp members 40, 44 each further include a holding portion 52, 54, respectively, integrally formed with the pair of corresponding flange portions 48, 48′ and 50, 50′. The clamp members 40, 44 cooperate to hold a television, such as a television having a size and shape similar to that of a plasma screen television (depicted in phantom as 56 in FIG. 2), therebetween.

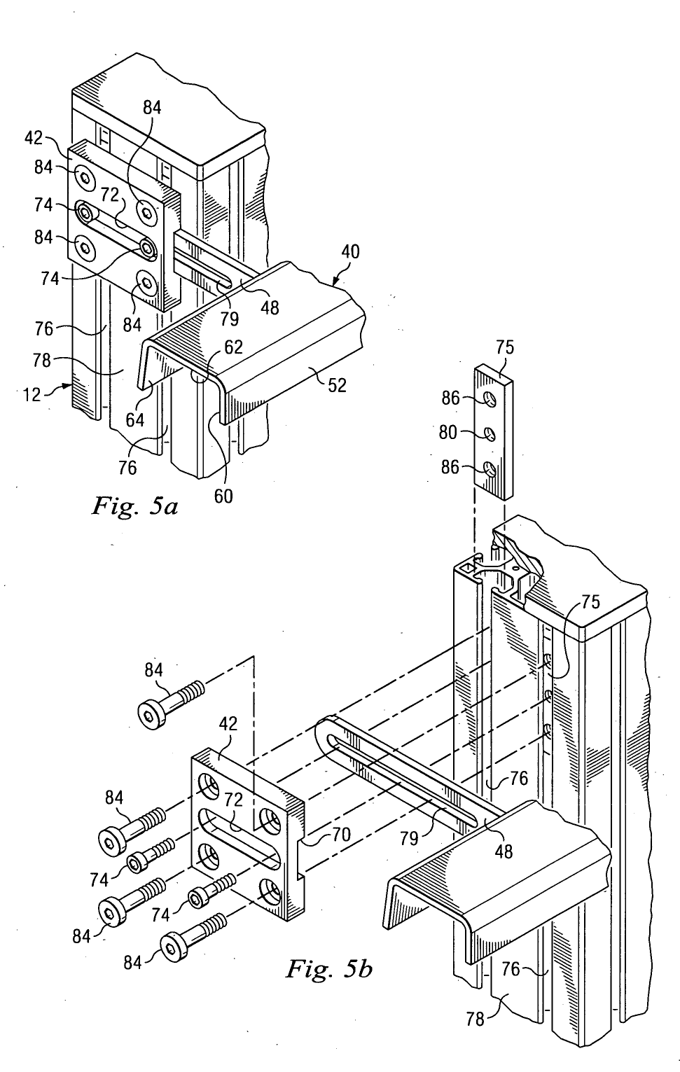

Referring to FIG. 5a, to facilitate holding of a television (not shown), the holding portion 52 includes a flat front restraint 60, an upper restraint 62, and a rear angled restraint 64, which cooperate to provide the holding portion with a cup-like shape. The cup-like shape provided by the restraints 60, 62, 64 accommodates receipt of an edge of a television therein. It is understood that the holding portion 54 is shaped in a similar, yet opposed, manner.

Referring again to FIGS. 1 and 2, the clamp members 40, 44 are adjustable in the horizontal and vertical directions to accommodate televisions of different sizes and shapes. As such, the clamp member 40 is adjustable in the horizontal direction via adjustment of the flange portions 48, 48′ within the adjustable brackets 42, 42′, respectively, and in a similar manner, the clamp member 44 is adjustable in the horizontal direction via adjustment of the flange portions 50, 50′ within the adjustable brackets 46, 46′, respectively.

For sake of clarity, only one flange portion 48 and its interaction with the adjustable bracket 42 will be described. Referring to FIGS. 5a and 5b, the flange portion 48 extends into a groove 70 defined in the adjustable bracket 42. An elongated slot 72 is formed in the adjustable bracket 42 through which a pair of connectors 74 transversely extend to engage corresponding receiving members 75 disposed in the vertical support 12. In one embodiment, the receiving members 75 are extended nuts, which are disposed in a pair of channels 76 defined in an outer side 78 (relative to the other vertical support 12′) of the vertical support 12. More particularly, the connectors 74 are each adapted to additionally extend through a slot 79 defined in the flange portion 48 to thread into corresponding openings 80 defined in the corresponding receiving member 75. The heads of the connectors 74 engage the flange portion 48 when secured to the corresponding receiving members 78, thereby retaining the flange portion, and therefore, the clamp member 40 at a desired horizontal position. Accordingly, the clamp member 40 is horizontally adjustable within the groove 70, and can be adjusted to any number of horizontal positions by loosening the connectors 74 and moving the flange portion 48. It is understood that the flange portions 48′, 50, 50′ are horizontally adjustable in a substantially similar manner.

Moreover, the clamp members 40, 44 are adjustable in the vertical direction via adjustment of the adjustable brackets 42, 42′ and 46, 46′, respectively, along the vertical supports 12, 12′, respectively. It is understood that the clamp members 40, 44 and their associated adjustable brackets 42, 42′ and 46, 46′ may each be referred to as a clamp assembly. For sake of clarity, only one adjustable bracket 42 and its interaction with the vertical support 12 will be described. A plurality of connectors 84 are adapted to extend transversely through the adjustable bracket 42 to thread into corresponding openings 86 defined in the receiving members 75. The engagement of the connectors 84 into the openings 86 provides a compressive force sufficient to lock the adjustable bracket and receiving member to the vertical support 12 at a desired position. As can be appreciated, should another position of the adjustable bracket 42 be desired, the connectors 74, 84 may be loosened from the receiving members 75, and the adjustable bracket and receiving members can be vertically adjusted to another position, whereupon the connectors 74, 84 are reengaged with the receiving members 75, and the vertical support 12. The channels 76 extend along a substantial portion of the outer side 78 of the vertical support 12, which allows for an appreciable degree of vertical adjustment of the receiving members 75, and therefore, the adjustable bracket 42. Referring again to FIG. 1, it is understood that the adjustable brackets 46 and 42′, 46′ are vertically adjustable along the vertical supports 12, 12′ in a substantially similar manner.

In operation, and with reference to FIGS. 1-5b, the stand 10 is assembled to hold the television 56 between the clamp members 40, 44. The stand 10 can be altered to accommodate relatively smaller televisions by loosening the connectors 74, 84 associated with the adjustable brackets 42, 46 and 42′, 46′, adjusting the clamp members 40, 44 vertically towards one another, and reengaging the adjustable brackets with the vertical supports 12, 12′, respectively. Alternatively, the stand 10 can be altered to accommodate relatively larger televisions by loosening the connectors 74, 84 associated with the adjustable brackets 42, 46 and 42′, 46′, adjusting the clamp members 40, 46 vertically away from one another, and reengaging the adjustable brackets with the vertical supports 12, 12′, respectively.

Moreover, if desired, the television 56 is then moved back (e.g., towards the vertical supports 12, 12′ as viewed in FIG. 1) until it contacts the stop members 32, 32′, which are provided as an abutment surface for the television to abut against the stand 10. This is accomplished by loosening the connectors 74 and moving the flange portions 48, 48′ and 50, 50′ of the clamp members 40, 44, respectively, within the grooves 70 of the corresponding adjustable brackets 42, 42′, 46, 46′. Once the television 56 contacts the stop members 32, 32′, the clamp members 40, 44 are secured in the grooves 70 of the corresponding adjustable brackets 42, 42′, 46, 46′ by reengaging the connectors 74 with the vertical support 12, which secures the television to the stand 10 and prevents front to back movement (as viewed in FIG. 1).

Movement of the stand 10 is facilitated by the wheels 34, 34′ and the handle 36. For example, after the television 56 has been secured to the stand 10, the stand may be tilted rearwards (as viewed in FIG. 1) onto the wheels 34, 34′, held at the handle 36, and moved as desired.

Accordingly, televisions of different sizes and shapes may be accommodated by the stand 10 by adjustment of the clamp members 40, 44. For example, the clamp members 40, 44 may accommodate televisions of different heights, different widths, and different depths.

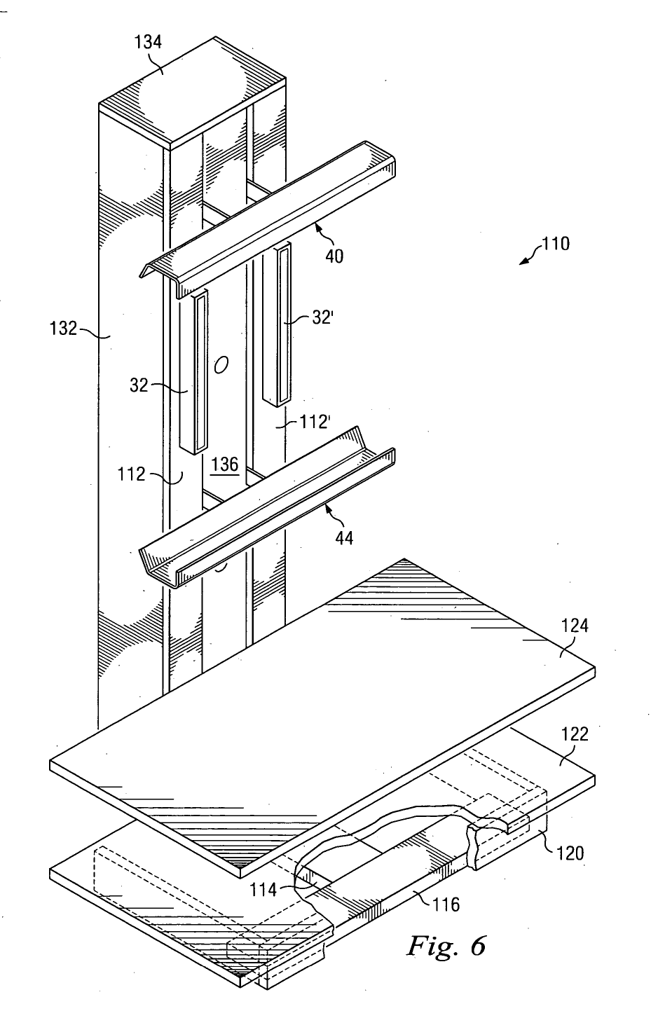

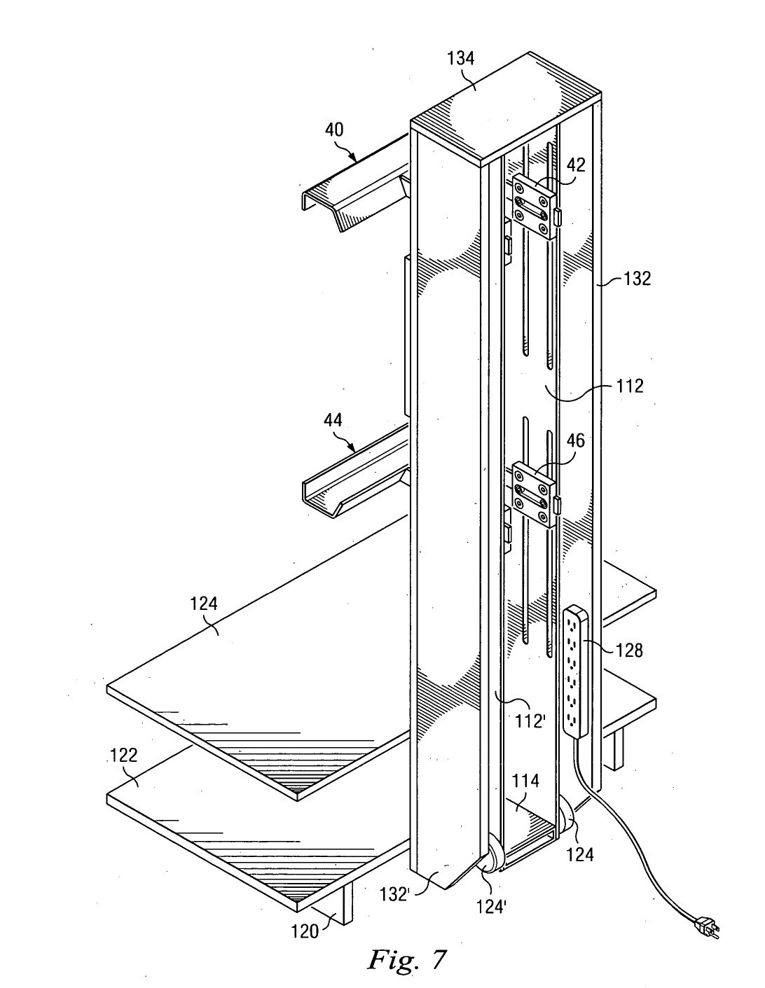

As can be appreciated, the above-described clamp members 40, 44 and adjustable brackets 42, 42′ and 46, 46′ can be used with alternative adjustable television stands without departing from the spirit and scope of the disclosure. For example, and referring now to FIGS. 6 and 7, an alternative television stand is generally depicted by reference numeral 110. The stand 110 includes a pair of horizontally-spaced, vertical supports 112, 112′. As with FIGS. 1-4, the components on the right side of the stand 110 in FIG. 6 (on the left side of the stand 110 in FIG. 7) are given an apostrophe (“′”) to simplify the following explanation of the stand 110. The lower ends of the vertical supports 112, 112′ are connected in any conventional manner to one end of a horizontal support member 114. The opposing end of the horizontal support member 114 intersects with a horizontal crosspiece 116 that is perpendicular to the horizontal support member 114, thereby providing an appreciable degree of stability to the stand 110.

A support panel 120 is disposed around the horizontal support member 114 and the horizontal crosspiece 116, which effectively hides these structures from frontal view (as viewed in FIG. 6). A shelf 122 is disposed across the panel 120 to provide a storage area for the stand 110. An additional shelf 124, vertically spaced from the shelf 122, is also provided and is supported on the stand 110 in any conventional manner. Referring specifically to FIG. 7, the stand 110 includes a pair of wheels 124, 124′ and a handle (not shown), which aid in movement of the stand. An electrical connection or power strip 128 is provided to facilitate the provision of power to the television and/or other electrical components that may be associated with the stand 110.

Referring again to FIGS. 6 and 7, a pair of sidewalls 132, 132′ are disposed adjacent to the vertical supports 112, 112′, respectively, for concealing a portion of the vertical supports from frontal view (as viewed in FIG. 6), and a top plate 134 is connected between the vertical supports in any conventional manner. Additionally, a vertically-extending panel 136 is disposed between the vertical supports 112, 112′ in any conventional manner.

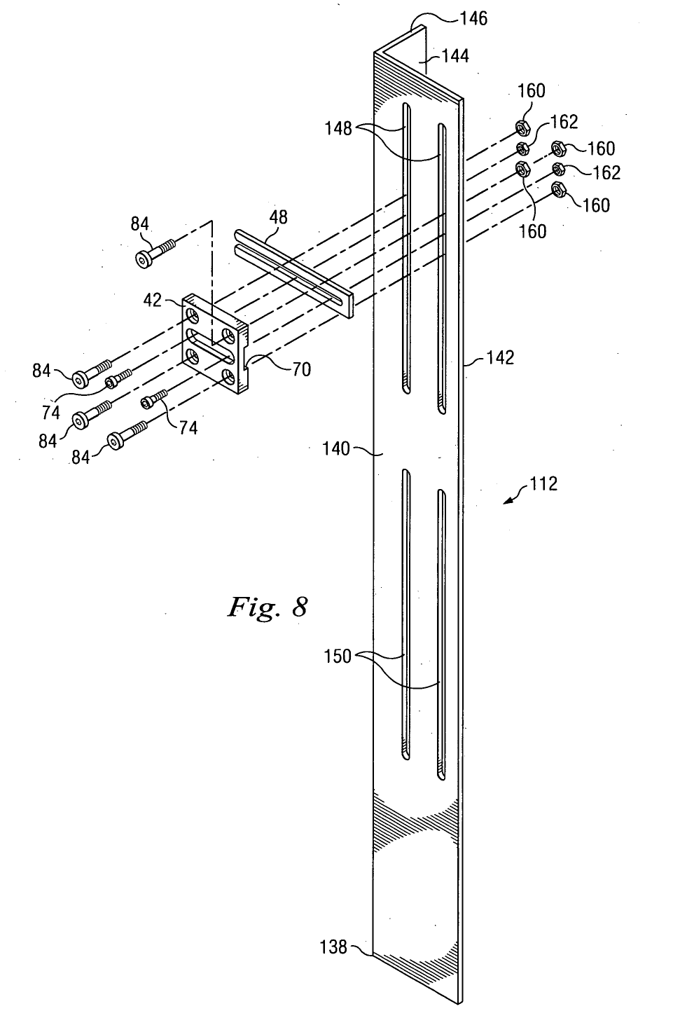

Because of the similarity between the vertical supports 112, 112′, only the vertical support 112 is described. Referring to FIG. 8, the vertical support 112 includes a single member with an angle or “bend” 138 that is approximately ninety degrees. The bend 138 results in four faces 140, 142, 144, 146. A first pair of parallel slots 148 are formed through the vertical support 112 to connect the faces 140, 142, and are located proximate to the upper end of the vertical support 112 (as viewed in FIG. 8). A second pair of parallel slots 150 are formed through the vertical support 112 to connect the faces 140, 142 and are located between the first pair of slots 148 and the lower end of the vertical support. Both pairs of slots 148 and 150 are parallel with the length of the vertical support 112.

The face 140 is oriented towards the vertical support 114 (FIG. 6) and perpendicular to the front of the stand 110 (as viewed in FIG. 6), with the slots 148 and 150 being defined in a plane that is parallel to a plane in which corresponding slots are defined in the vertical support 112′. The face 146 is oriented towards the front of the stand 110. Accordingly, the slots 148, 150 cooperate with the adjustable brackets 42, 46 and the slots associated with vertical support 112′ cooperate with the adjustable brackets 42′, 46′ to allow for vertical adjustment of the clamp members 40, 44 along the vertical supports 112, 112′.

For sake of clarity, only one adjustable bracket 42 and its interaction with the vertical support 112 will be described. The adjustable bracket 42 can be pressed against the face 140 of the vertical support 112 such that the groove 70 defined in the adjustable bracket is perpendicular to the slots 148. The connectors 84 can then be inserted through the adjustable bracket to secure the adjustable bracket to the vertical support 112 via a corresponding plurality of nuts 160. Moreover, the flange portion 48 (a portion of which is shown in FIG. 8) of the clamp member 40 can be inserted into the groove 70 of the adjustable bracket 42 and the clamp member 40 can be vertically adjusted by movement of the adjustable bracket along the slots 148.

The clamp member 40 can also be horizontally adjusted via the connectors 74 and a corresponding pair of nuts 162. Specifically, the connectors 74 extend through the adjustable bracket 42 to engage the flange portion 48, and are secured to the vertical support 112 via the corresponding nuts 162. It is understood that the additional adjustable brackets 46 and 42′, 46′ interact with the vertical supports 112, 112′ in substantially the same manner, and as such, the clamp members 40 and 44 associated with the stand 110 cooperate to hold televisions having different sizes and shapes.

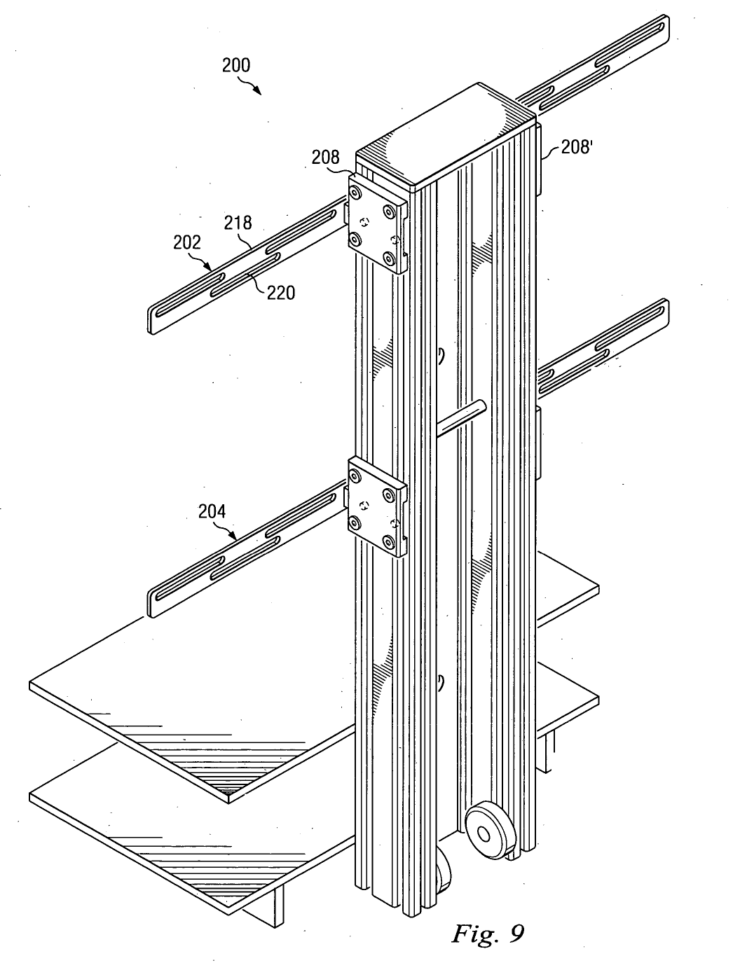

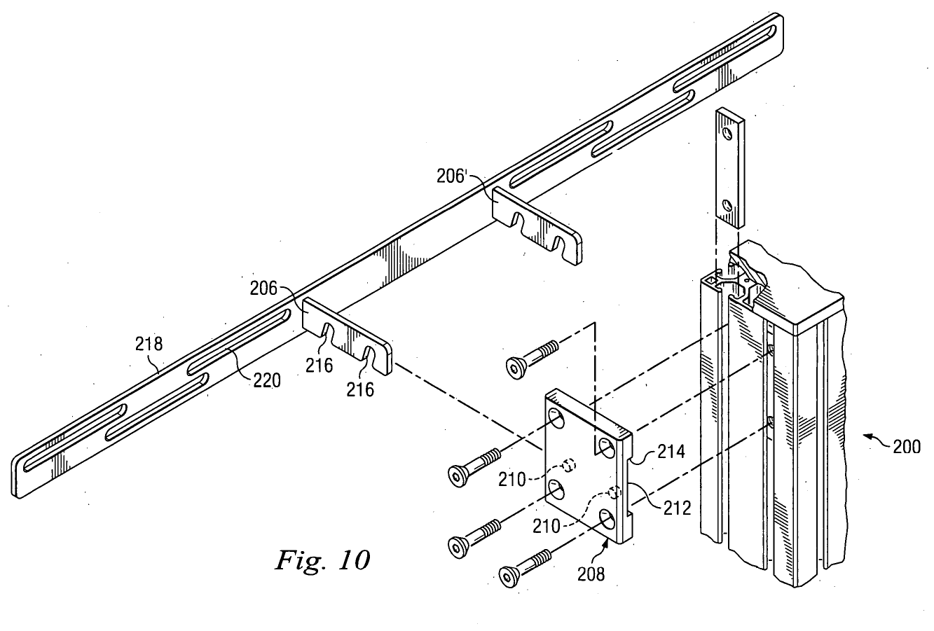

Referring to FIGS. 9 and 10, collectively, illustrated are perspective views of another embodiment of the adjustable television stand 10 shown in FIGS. 1-5b, herein designated by the reference numeral 200. The adjustable television stand 200 may be substantially similar to the adjustable television stand 10 other than those features described below.

The adjustable television stand 200 includes a pair of clamping members 202, 204 for retaining a television (not depicted). The clamping members 202, 204 may be substantially similar, such that only the upper clamping member 202 and its interaction with the stand 200 is described below.

The clamping member 202 includes a pair of flange portions 206, 206′ for engaging a pair of adjustable brackets 208, 208′ slidably engaged with the stand 10. For the sake of clarity, only the interaction of flange portion 206 with adjustable bracket 208 will be described in detail. The adjustable bracket 208 is similar to the adjustable bracket 42 except that a pair of protrusions 210 extends from an inner surface 212 of a groove 214 of the adjustable bracket 208. The flange portion 206 includes a pair of notches 216 formed in an underside thereof (as viewed in FIG. 10). The notches 216 are adapted to align with and engage the corresponding pair of protrusions 212 when the flange portion 206 is inserted into the adjustable bracket 208.

The clamping member 202 further includes a retaining portion 218 integrally formed with or welded, bonded, or otherwise coupled to the flange portions 206, 206′ and extending in a generally transverse direction relative to the flange portions. The retaining portion 218 includes a plurality of slots 220 formed therethrough. The slots 220 provide openings through which screws (not shown) or other connector members may be disposed to secure the retaining portion to the backside of a television (not shown). In one embodiment, the slots 220 are disposed in an overlapping manner to accommodate a variety of connection orientations. However, the number and disposal of such slots 220 through the retaining portion 218 may vary, and are not limited to the configuration of the illustrated embodiment.

In operation, the clamping member 202 may be secured to the stand 200 by inserting the flange portion 206 into the adjustable bracket 208 via the groove 214 defined in the adjustable bracket. The flange portion 206 is then aligned with and inserted over the protrusions 210 extending from the adjustable bracket 208. The adjustable bracket 208 can then be vertically adjusted and secured to the stand 200 in the manner as described with respect to embodiments discussed above. It is understood that the adjustable bracket 208′ and the adjustable brackets associated with the lower clamping member 204 are also adjusted and secured in a substantially similar manner. Accordingly, the clamping members 202, 204 are vertically adjustable along the stand 200 to a variety of vertical positions.

A television may then be secured to the clamping members 202, 204 by engaging screws or other connector members through the slots 220 formed in the retaining portions of the clamping members. Upon securing the television to the clamping members 202, 204, the television may be vertically adjusted to a desired height.

It is understood that several modifications can be made to the above-described adjustable television stands 10, 110, 200 without departing from the teachings of the disclosure. For example, the shelves associated with the stands 10, 110, 200 may be shaped and/or supported in a variety of ways, may vary in number relative to the illustrated embodiments, or they may be omitted entirely. Moreover, the stands 10, 110, 200 may be supported on a surface in a variety of ways other than angled supports 18, 20 and perpendicular supports 114, 116, respectively.

Additionally, although described for use with televisions, the stands 10, 110, 200 may be used with other electronic devices, or in some instances, non-electronic devices. Also, although the stands 10, 110, 200 have been described as including a pair of supports 12, 12′ and 112, 112′, respectively, the supports may be a single, unitary structure, or in other embodiments, the supports may include a plurality of modular components.

Furthermore, the holding portions 52, 54 are not limited to the shape as described. For example, the rear restraint 64 may be perpendicular to the upper restraint 62, or the holding portions may be configured in other manners to accommodate televisions having different shapes and sizes.

Still further, although the adjustable brackets 42, 42′, 46, 46′ have been described as accommodating six connectors, it is understood that the brackets may be adapted to accommodate any number of connectors. Moreover, a single adjustable bracket may be used to vertically adjust the clamp member 40, and similarly, a single adjustable bracket may be used to vertically adjust the clamp member 44. In such an embodiment, the clamp members 40, 44 each include only one flange portion. Additionally, although not depicted, the clamp members 40, 44 may be side clamp members rather than upper and lower clamp members, and therefore, one clamp member may be adjustable along one support, or a first side of a support, and the other clamp member may be adjustable along the other support, or the other side of a support.

With respect to the stand 110, the support panel 120 and the sidewalls 132, 132′ may have alternative configurations, or they may be omitted entirely.

Moreover, in other embodiments, various types of connectors may be used and components may align with and connect to other components in different manners. It is also understood that all spatial references, such as “horizontal,” vertical, “top,” “upper,” “lower,” “bottom,” “left,” and “right,” are for illustrative purposes only and can be varied within the scope of the disclosure. While the preceding description shows and describes one or more embodiments, it will be understood by those skilled in the art that various changes in form and detail may be made therein without departing from the spirit and scope of the present disclosure. Additionally, in the claims, means-plus-function clauses are intended to cover the structures described herein as performing the recited function and not only structural equivalents, but also equivalent structures.

Thus, the present disclosure provides an adjustable stand including at least one support and at least one adjustable bracket engaged with and adjustable along the support. The adjustable bracket includes a recess in a surface adjacent the support and at least one protrusion extending from a surface of the recess. The adjustable stand also includes at least one mounting bracket including: (1) at least one retaining portion configured to interface with a device to be supported by the adjustable stand; and (2) at least one flange portion configured to engage with the recess and the protrusion.

Another embodiment of an adjustable stand according to aspects of the present disclosure includes at least one support, at least one adjustable bracket slidably engaged with the support, and at least one mounting bracket. In such an embodiment, the mounting bracket may include a retaining portion and at least one flange portion, wherein the retaining portion may be configured to interface with a device to be supported by the adjustable stand, and the flange portion may be configured to engage at least one of the support and the adjustable bracket at least partially in response to the engagement of the support and the adjustable bracket.

The present disclosure also provides a monitor display assembly including a monitor, at least one support, at least one adjustable bracket slidably engaged with the support, and at least one mounting bracket. The mounting bracket may include a retaining portion and at least one flange portion, wherein the retaining portion may be coupled to the monitor, and wherein the flange portion may be configured to engage at least one of the support and the adjustable bracket at least partially in response to the engagement of the support and the adjustable bracket.

A method of manufacturing an adjustable stand is also introduced in the present disclosure. In one embodiment, the method includes orienting a flange portion of a mounting bracket within a recess of an adjustable bracket, coupling the adjustable bracket slidably to a support, and orienting the adjustable bracket by sliding relative to the support. The method may also include rigidizing the coupling between the adjustable bracket and the support, wherein at least one of the coupling and the rigidizing engages the flange portion with at least one of the adjustable bracket and the support. A retaining portion of the mounting bracket may also be coupled to a device to be supported by the adjustable stand.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. An adjustable stand, comprising:
at least one support;
at least one adjustable bracket engaged with and adjustable along the support and including:
a recess in a surface adjacent the support; and
at least one protrusion extending from a surface of the recess; and
at least one mounting bracket including:
at least one retaining portion configured to interface with a device to be supported by the adjustable stand; and
at least one flange portion configured to engage with the recess and the protrusion.

2. The adjustable stand of claim 1 wherein the at least one support comprises a pair of opposing supports.

3. The adjustable stand of claim 2 further comprising a handle extending between the supports.

4. The adjustable stand of claim 1 wherein the at least one adjustable bracket comprises a pair of adjustable brackets on opposing sides of the support and the at least one flange portion includes an opposing pair of flange portions each configured to engage with the support and the protrusion of a corresponding one of the adjustable brackets.

5. The adjustable stand of claim 1 wherein the recess has a depth about equal to a thickness of the flange portion.

6. The adjustable stand of claim 1 wherein the recess has a width about equal to a height of the flange portion.

7. The adjustable stand of claim 1 wherein the recess has a first profile substantially similar to a second profile of a portion of the flange portion engaged by the recess.

8. The adjustable stand of claim 1 wherein the at least one protrusion comprises a plurality of protrusions extending from the recess surface.

9. The adjustable stand of claim 1 wherein the retaining portion includes a plurality of slots configured to receive at least one fastener coupled to the device.

10. The adjustable stand of claim 1 wherein the flange portion includes a first profile substantially conforming to a second profile of the recess, the first profile including a notched portion for receiving the protrusion.

11. The adjustable stand of claim 1 further comprising at least one receiver member slidably disposed within a channel of the support and couplable to the adjustable bracket.

12. An adjustable stand, comprising:
at least one support;
at least one adjustable bracket slidably engaged with the support; and
at least one mounting bracket including a retaining portion and at least one flange portion, the retaining portion configured to interface with a device to be supported by the adjustable stand, the flange portion configured to engage at least one of the support and the adjustable bracket at least partially in response to the engagement of the support and the adjustable bracket.

13. The adjustable stand of claim 12 wherein:
the at least one support comprises a pair of opposing supports;
the at least one adjustable bracket comprises a pair of opposing adjustable brackets each engaged with a corresponding one of the supports; and
the at least one flange portion comprises a pair of opposing flanges each configured to engage a corresponding one of the supports and a corresponding one of the adjustable brackets at least partially in response to the engagement of the corresponding one of the supports and the corresponding one of the adjustable brackets.

14. A monitor display assembly, comprising:
a monitor;
at least one support;
at least one adjustable bracket slidably engaged with the support; and
at least one mounting bracket including a retaining portion and at least one flange portion, the retaining portion coupled to the monitor, the flange portion configured to engage at least one of the support and the adjustable bracket at least partially in response to the engagement of the support and the adjustable bracket.

15. The monitor display assembly of claim 14 wherein:
the at least one support comprises a pair of opposing supports;
the at least one adjustable bracket comprises a pair of opposing adjustable brackets each engaged with a corresponding one of the supports; and
the at least one flange portion comprises a pair of opposing flanges each configured to engage a corresponding one of the supports and a corresponding one of the adjustable brackets at least partially in response to the engagement of the corresponding one of the supports and the corresponding one of the adjustable brackets.

16. The monitor display assembly of claim 14 wherein the monitor is selected from the group consisting of:
a personal computer monitor;
a television.

17. The monitor display assembly of claim 14 wherein the monitor is a plasma television.

18. A method of manufacturing an adjustable stand, comprising:
orienting a flange portion of a mounting bracket within a recess of an adjustable bracket;
coupling the adjustable bracket slidably to a support;
orienting the adjustable bracket by sliding relative to the support;
rigidizing the coupling between the adjustable bracket and the support, wherein at least one of the coupling and the rigidizing engages the flange portion with at least one of the adjustable bracket and the support; and
coupling a retaining portion of the mounting bracket to a device to be supported by the adjustable stand.

19. The method of claim 18 wherein:
orienting the flange portion includes orienting a first flange portion of a mounting bracket within a first recess of a first adjustable bracket and orienting a second flange portion of the mounting bracket within a second recess of a second adjustable bracket;
coupling the adjustable bracket includes coupling a first adjustable bracket slidably to a first support and coupling a second adjustable bracket slidably to a second support;
orienting the adjustable bracket includes orienting the first and second adjustable brackets by sliding relative to the first and second supports, respectively; and
rigidizing the coupling includes rigidizing first and second coupling between the first and second adjustable brackets and the first and second supports, respectively.

20. The method of claim 18 wherein the device is a plasma television.
